(19) United States
(12) Patent Application Publication
(10) Pub. No.: US 2023/0131425 A1
(43) Pub. Date: Apr. 27, 2023

(54) SYSTEM AND METHOD FOR NAVIGATING WITH THE ASSISTANCE OF PASSIVE OBJECTS

(71) Applicant: INDOOR ROBOTICS LTD., Ramat-Gan (IL)

(72) Inventors: AMIT MORAN, TEL-AVIV (IL); DORON BEN-DAVID, PETACH TIKVA (IL); NATY SHEMER, GIVATAYIM (IL); SVETLANA POTYAGYLO, HAIFA (IL); ITAY GABIZON, GIVATAYIM (IL)

(21) Appl. No.: 17/509,257

(22) Filed: Oct. 25, 2021

(51) Int. Cl. G05D 1/02; G06T 7/73; G06T 7/50; G06T 7/60

(52) U.S. Cl. CPC G05D 1/0234; G05D 1/0246; G06T 7/74; G06T 7/50; G06T 7/60

(57) ABSTRACT

A method for estimating a location of a mobile robot in an area, the area having multiple passive beacons, the method including capturing images by an image sensor of the mobile robot, where the multiple passive beacons have substantially identical patterns, identifying patterns of at least one passive beacon of the multiple passive beacons from the captured images, selecting a specific passive beacon of the multiple passive beacons to estimate a location of the mobile robot, extracting the mobile robot's location from the location of the specific passive beacon, computing the mobile robot's direction by a pattern of the specific passive beacon.

### FIELD

The invention relates generally to navigating with the assistance of passive objects.

### BACKGROUND

One of the main challenges in autonomous mobile robots is navigation, as robots are required to move from one point to another point in order to perform a task. In outdoor areas, mobile robots may navigate using GPS signals. Using GPS is not an option at indoor areas. Hence, there is a need to use alternative techniques for indoor navigation.

Given a map of the surrounding distinguishable features (such as corners, high contrast points, walls, etc.), the robot can identify those features and localize itself in the map and therefore in the world. Other techniques are using predefined easily detected beacons in the area in order to help the robot localize itself. Some techniques are using 2D barcodes and cameras to provide the location of the robot. Those 2D barcodes are large and very noticeable by the environment. Furthermore, those techniques are problematic in dark environments. Other techniques are using arrays of IR LEDs in a specific pattern, or blinking IR LEDs in order for the robot to localize itself, and sometimes RF beacons are being used for triangulation. Those are more discrete but require a source of power (such as batteries or wall outlets). Moreover, beacons are usually complex and in order to allow navigation in a large area, many different and unique beacons are needed, requiring more complex installation, managing more inventory and increase costs in general.

### SUMMARY

The invention, in embodiments thereof, discloses systems and methods to place simple, not necessarily distinguishable, passive beacons in the environment to allow robot localization.

In one embodiment a method is provided for estimating a location of a mobile robot in an area, the area having multiple passive beacons, the method including capturing images by an image sensor of the mobile robot, wherein the multiple passive beacons have substantially identical patterns, identifying patterns of at least one passive beacon of the multiple passive beacons from the captured images, selecting a specific passive beacon of the multiple passive beacons to estimate a location of the mobile robot, extracting the mobile robot's location from the location of the specific passive beacon, computing the mobile robot's direction by a pattern of the specific passive beacon.

In some cases, the method further including the mobile robot storing multiple different patterns of passive beacons located in the area, extracting a specific pattern from the captured images, comparing the specific pattern with at least one of the multiple different patterns.

In some cases, the method further including storing locations of the multiple passive beacons, obtaining an estimated location of the mobile robot from sensors located in the robot, determining an order of comparing the specific pattern with the multiple different patterns according to the locations of the multiple passive beacons and the robot's estimated location.

In some cases, the method further including maneuvering image sensors of the mobile robot relative to a body of the mobile robot, the image sensor is maneuvered to point towards an estimated location of the multiple beacons.

In some cases, the method further including estimating a distance between the mobile robot and candidate passive beacons from which reflections are captured by the image sensor, filtering the candidate passive beacons according to the estimated distance from the mobile robot.

In some cases, the method further including the mobile robot storing geometric characteristics of the passive beacons, filtering reflections from multiple passive beacons that do not match the geometric characteristics of the passive beacons.

In some cases, the method further including estimating that the reflection represents the specific passive beacon of multiple candidate beacons based on data from sensors of the mobile robot.

In some cases, the method further including emitting light from the mobile robot when moving in the area and capturing an image in the direction of the emitted light to collect reflections to the light.

In some cases, specific passive beacon is a passive beacon closest to the mobile robot at the time of capturing the images

In some cases, the method further including extracting the robot's height from the image based on a size of the pattern in the captured images.

In some cases, a single passive beacon of the multiple passive beacons having a unique pattern, wherein other patterns are associated with at least two passive beacons of the multiple passive beacons.

In another embodiment a mobile robot is provided, including a body, an actuator for moving the body, a memory for storing one or more patterns of multiple passive beacons placed in an area and locations of the multiple passive beacons, image sensor for capturing images, a processor configured to identify patterns of at least one passive beacon of the multiple passive beacons from the captured images, select a specific passive beacon of the multiple passive beacons to estimate a location of the mobile robot, extract the mobile robot's location from the location of the specific passive beacon, compute the mobile robot's direction by a pattern of the specific passive beacon.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method of navigating in an area, according to an exemplary embodiment of the invention;

FIG. 2 shows a method of processing candidates' data when matching candidates to positions, according to an exemplary embodiment of the invention;

FIG. 3 shows an area having passive beacons, according to an exemplary embodiment of the invention, and;

FIG. 4 schematically shows a mobile robot navigating in an area using passive beacons, according to an exemplary embodiment of the invention.

### DETAILED DESCRIPTION

The technical challenge solved using the subject matter is to navigate in indoor facilities, such as buildings, warehouses and the like. More specifically, the technical challenge is to navigate where no active outside aid is around to provide the robot its location, the aid may be cameras capturing the robot or beacons.

The technical solution disclosed in the subject matter is to place reflective elements in the indoor facility in predefined locations, and emit light from a light emitter in a mobile robot towards a general location of the reflective elements. The reflective elements may be identical, which results in reflecting the same pattern, or substantially identical pattern, in order to reduce installation costs. Substantially identical patterns are defined as pattern which are not identical, but appear to be identical to a person, even if they are slightly different, for example due to a printing offset. The identical pattern requires the robot's processor to determine which reflective element reflected the light emitted by the robot, for example whether the reflective element is one of the passive beacons or another element. Some elements in the environment, other than the passive beacons, might be reflective as well and therefore the passive beacons' pattern is needed and the robot is configured to identify which points are part of the pattern and which points are not. If the pattern was not identical, the specific reflective element would be identified according to the pattern, but installation and maintenance of the passive elements would require much more time, and a bigger inventory of the reflective elements (at least one spare reflective element with each pattern).

The term “passive beacons” refers to physical objects that do not emit energy or signals. The passive beacons reflect energy (for example light or any material) when energy is emitted towards them. The passive beacons may be designed to include a pattern, such as points, lines or any other energy reflecting pattern, directed towards the same azimuth or towards the same object in the area in which the passive beacons are installed. The object may be an entrance to the area, such as entrance to a warehouse. In some cases, at least some of the passive beacons are of a material (such as special ink) which is highly reflective characteristics, for example reflecting at least 75 percent of the energy heating the beacon.

The term “navigation”—refers to the robot's ability to determine its own position in its frame of reference and then to plan a path towards some goal location.

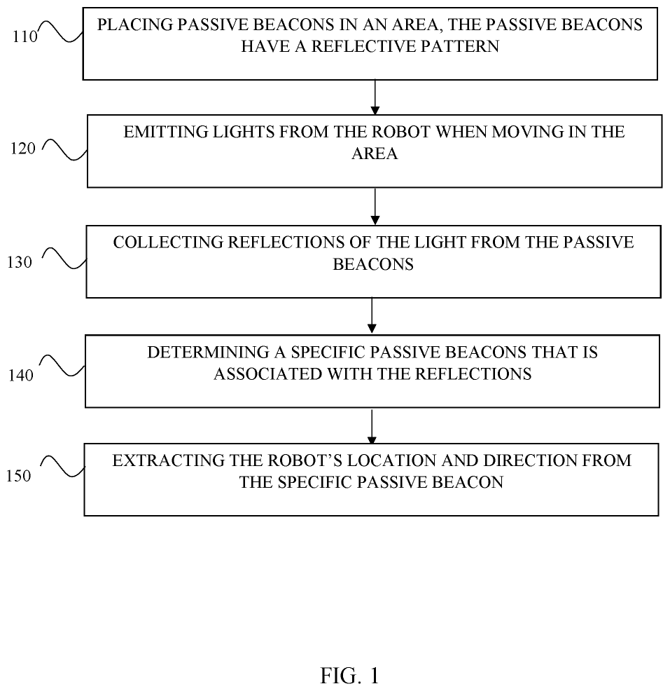

FIG. 1 shows a method of navigating in an area, according to an exemplary embodiment of the invention.

Step 110 discloses placing passive beacons in an area, the passive beacons have a reflective pattern. The pattern is not necessarily reflective and may also be a regular image as long as the image is distinguishable. The pattern may or may not be reflective and that the reflectiveness is just a method in order to allow the robot to detect the pattern easily. The area is defined by users and/or operators of the mobile robot. The area may be dark during at least certain times, such as during nights. The passive beacons may be placed on a floor, wall, on the ground, on a ceiling, or on an object coupled to the area's ground, such as table, pole, and the like. The beacons' locations, orientation and heights are inputted into a memory of the robot, or a memory accessible to the robot's processor.

The beacons may be placed at identical distances, for example every 12 meters, or at various distances. The processor may use a distance between subsequent beacons when computing the robot's location. The pattern may include points, lines, dots, or other shapes which are detectable by a sensor. In some cases, the pattern is asymmetric, meaning that the pattern looks different from various directions. Hence, the pattern has a direction. The pattern may comprise three dots having different distances between them. The farther point of the three may represent a heading or a direction of the beacon. In some cases, when placing the passive beacons, all the beacons' headings are identical, directed at the same azimuth.

In some cases, the area may have a single pattern for all the passive beacons. In some other cases, the area may have multiple different patterns for the passive beacons. For example, a large warehouse may have 2,000 passive beacons, 500 passive beacons having pattern #1, 500 passive beacons having pattern #2 and 1,000 passive beacons having pattern #3. The locations of the beacons, and the three different patterns, may be stored in the robot's memory. This way, the robot can select from multiple close passive beacons according to the pattern appearing in an image captured by the robot. The captured images used to navigate may be captured by another robot and sent to the mobile robot, in case the mobile robot does not have capabilities to identify the pattern, or identify the passive beacons based on images.

In some other cases, one of the passive beacons have a unique pattern, for example to mark a unique location, for example a docking station for the mobile robot, while other patterns are coupled to multiple passive beacons. Step 120 discloses emitting light from the robot when moving in the area. The light may be emitted in response to an event, such as an irregular sensor's measurement, or receipt of a command. The light may be emitted based on a set of rules, such as begin emitting light after 21:00, once every 1.5 seconds. The light's intensity and wavelength may be identical during the process, or vary, for example based on environmental measurements. For example, when the air is humid, emit light in the infra-red wavelength domain, otherwise emit light in 650 nano meters. The mobile robot may comprise multiple light emitters, for emitting different lights according to a command from the robot's processor. After emitting the light from the robot, an image sensor of the robot captures an image in the general direction of the light, to identify the pattern or shape of the beacon, in case there is a beacon in the direction of the light emitted by the robot.

In some exemplary cases, instead of emitting light, the robot captures images in its vicinity and processes the images to identify the beacons' patterns.

Step 130 discloses collecting reflections of the light from the passive beacons, for example by capturing images by an image sensor of the mobile robot. The patterns may be identical, or substantially identical in a manner that the reflections appear similar to a degree that sensors cannot identify differences between the patterns. The reflections may be received as an image. The reflections may be received as a heat map.

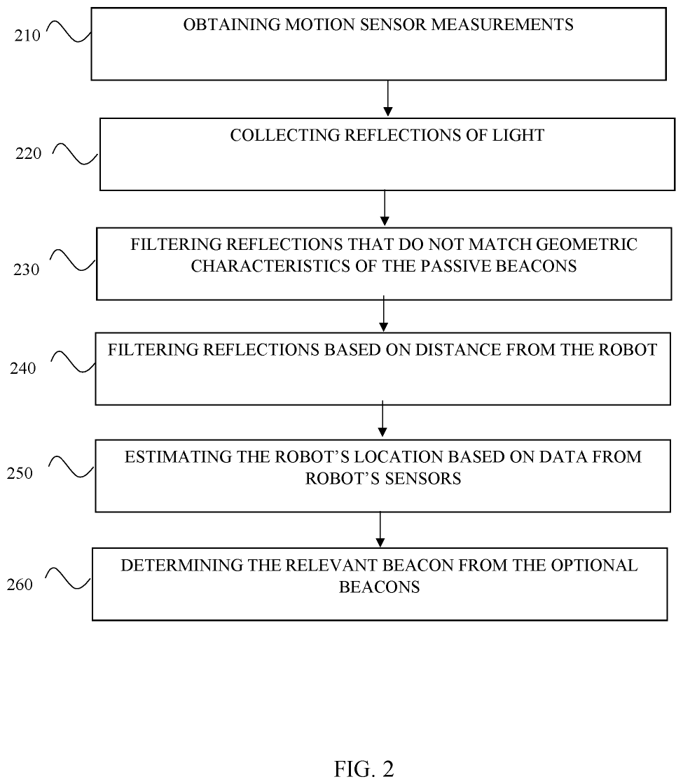

Step 140 discloses determining a specific passive beacons that is associated with the reflections. The determination is based on an estimated location of the robot, known locations of the robot, heading or direction of the beacon as collected from the reflection, and the like. The determination is described in detail in FIG. 2.

Step 150 discloses extracting the robot's location and direction from the specific passive beacon. The robot's location is computed based on the passive beacon's location, time elapsing from detecting the reflection from the beacon, the distance from the beacon, the robot's velocity after detecting the reflection from the beacon, angle between the robot's direction of movement and the beacon's heading and additional measurable properties. For example, in case the robot traveled 3.5 meters after detecting the reflection from the beacon, and the beacon's location is known, the angle between the robot's movement and the beacon's heading dictates the robot's location. For example, in case the angle is 90 degrees to the right, and the beacon's heading is directed at the north, the robot's location is 3.5 meters east to the beacon's location.

FIG. 2 shows a method of processing candidates' data when matching candidates to positions, according to an exemplary embodiment of the invention.

Step 210 discloses obtaining motion sensor measurements. The sensor measurements include information received from the robot's IMU, such as the yaw, roll and pitch of the robot. The sensor measurements may also include an estimated position of the robot in the world. The estimated position is defined by the robot's height and orientation in the three axes (x, y, z) as well as the yaw measurement. The robot also obtains a list of beacons and their location in the world (pose: position, height, orientation). The robot may also collect sensor measurements concerning the robot's advancement (odometry) using cameras and other sensors.

Step 220 discloses collecting reflections of light. The sensor module of the mobile robot samples light reflected at the sensors. The reflected light is stored in a memory for further processing. The mobile robot may comprise an image processor for processing images generated based on the collected reflections.

Step 230 discloses filtering reflections that do not match geometric characteristics of the passive beacons. The mobile robot stores the geometric characteristics of the passive beacons. The geometric characteristics may comprise a design or arrangement of shapes, such as lines, dots, symbols, elliptical shapes, polygonal shapes, the ratios between the shapes or the ratios of the distances between the shapes and the like. For example, the passive beacons comprise 5 dots and a straight line. In case the reflected light is significantly different from the 5 dots and a line, the reflection is filtered from consideration, meaning that the reflection is not returned from one of the passive beacons. In another example, the beacon consists of 3 elements, the distance between the first and second element is 5 cm while the distance between the second and the third elements is 8 cm.

Step 240 discloses filtering reflections based on distance from the robot. The distance may be in the horizontal place (x, y) or in a vertical plane (z). The distance may be measured using image processing techniques, such as measuring a number of pixels in the image between dots or lines in the reflected pattern. In case the number of pixels is too low, the distance is higher than a threshold and the beacon is irrelevant.

Step 250 discloses estimating the robot's location based on data from the robot's sensors. The robot measures its location periodically, for example once every 3 seconds. The measurement may include measuring acceleration over time, identifying objects in the robot's surroundings and the like. This way, the mobile robot can estimate its location in the area. However, this estimation is not sufficiently accurate, and the mobile robot requires the beacon to improve the location's accuracy. The mobile robot estimated location enables the mobile robot to estimate that the reflected light may be provided from only some of the beacons, for example only 6 candidate beacon patterns for 250 beacons placed in the area.

Step 260 discloses determining the relevant beacon from the candidate beacons. The determination may consider filtering possible beacons in case the patterns extracted from the captured image are associated with optional passive beacons in the robot's memory and the heights of those optional passive beacons with respect to the ground do not match the detected beacons height with respect to the ground which might be calculated using the sensed or calculated robot's height. The processor obtains the robot's height (for example a drone) and obtains the height of all beacons. The processor may then compute probabilities to the relevant beacons. The probability represents the likelihood that the reflected light was provided from a specific beacon. In case there is a specific beacon with a probability higher than a threshold, the specific beacon is selected as the relevant beacon.

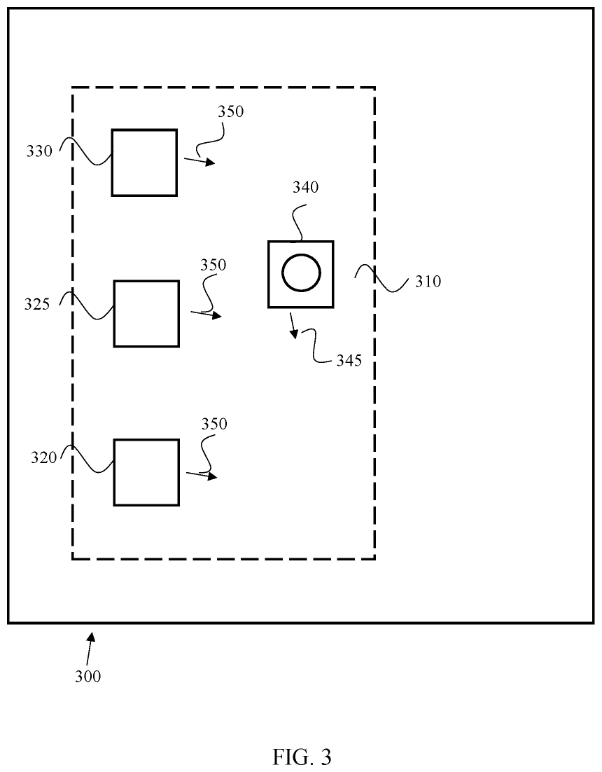

FIG. 3 shows an area having passive beacons, according to an exemplary embodiment of the invention. The area 300 may be an indoor area or an outdoor area. An indoor area may be covered at least partially with a ceiling, or surrounded by walls, poles, fence, or markings. The area may comprise a special subarea 310 in which navigation is more challenging for mobile robots. Challenging may refer to lack of wireless communication in the subarea 310, lack of illumination, lack of recognizable objects in the subarea 310 or any other reason that requires placing passive beacons therein. The passive beacons 320, 325, 330 may be adhered to a ceiling in the subarea 310, or to other objects. The height of the passive beacons 320, 325, 330 in the subarea 310 may be identical or within a predefined range, for example 10 centimeters between the highest beacon to the lowest beacon in the subarea 310. The passive beacons 320, 325, 330 may have an identical pattern. In some cases, the area 300 may include multiple subareas such as subarea 310, and the pattern in the passive beacons in subarea #1 are different from the pattern in the passive beacons in subarea #2, all the passive beacons in a subarea may have the same pattern.

When mobile robot 340 travels in the area 300, especially in the subarea 310, the mobile robot may emit light. The light is reflected by at least one of the passive beacons 320, 325, 330. The robot's movement direction 345 is computed by the robot's processor, according to a known heading 350 of the passive beacons 320, 325, 330.

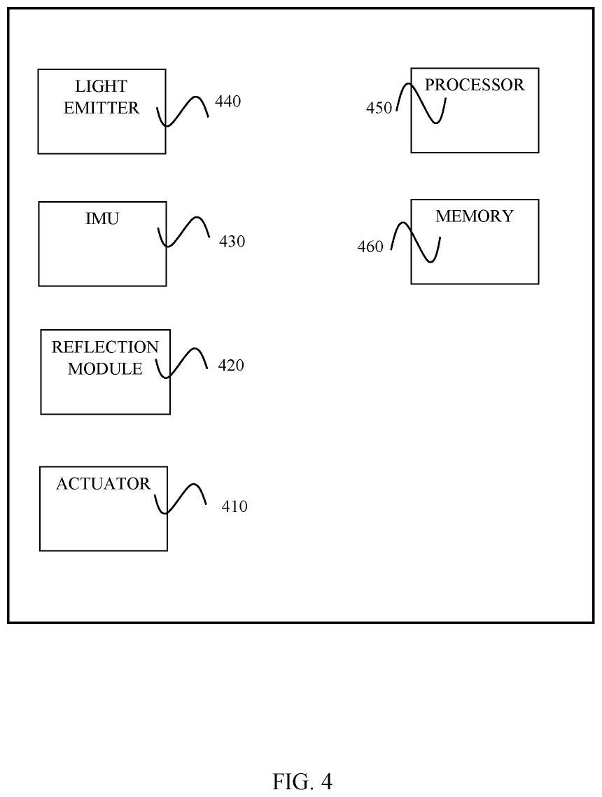

FIG. 4 schematically shows a mobile robot navigating in an area using passive beacons, according to an exemplary embodiment of the invention.

The mobile robot comprises an actuator 410 for moving the mobile robot. The actuator 410 may be a motor, an actuator and any mechanism configured to maneuver a physical member. The actuator 410 is coupled to a power source, such as a battery or a renewable energy member, such as a solar panel in case the area comprises or is adjacent to an outdoor area accessible to the mobile robot.

The mobile robot comprises a sensor module 420 for detecting the reflection from the passive beacons. The sensor module 420 may comprise one or more sensors, such as cameras. The cameras may be placed at the mobile robot in a way that enables it to detect reflections from the passive beacons. For example, in case the beacons are placed at the ceiling, the cameras are directed upwards. The sensor module may comprise multiple cameras directed at various directions from the mobile robot.

The mobile robot comprises an IMU 430. The mobile robot may also comprise an inertial measurement unit (IMU) 430 configured to measure the robot's specific force and angular rate. The measurements collected by the IMU 430 and by the sensor module 420 may be transmitted to or accessible by a processor 450 configured to process the measurements.

The mobile robot comprises a light emitter 440. The light emitter may emit lights in a visible wavelength, infra-red light, ultraviolet light, or any other signal that can be reflected by passive beacons. The light emitter 440 is coupled to the processor 450 and emits light in response to receiving a command from the processor 450. The light emitter 440 may emit light in response to a measurement of a sensor, such as amount of light in the robot's surroundings, temperature, smoke detection and the like.

The mobile robot comprises a processor 450 for controlling the operation in the mobile robot. The processor 450 may comprise one or more processors or microprocessors as desired by a person skilled in the art. The processor 450 is configured to execute a set of rules stored in a memory 460 of the mobile robot, or commands sent from a remote device, such as a server communicating with the mobile robot.

The mobile robot comprises a memory 460 for storing information. The information may be a set of instructions used to navigate in the area, for example to identify a specific passive beacon from the beacons placed in the area. The memory 460 may also store measurements collected by the sensor module 420.

The subject matter also comprises a system comprising multiple passive beacons placed in an area and a mobile robot. The mobile robot comprising a body; an actuator for moving the body; a memory for storing one or more patterns of multiple passive beacons placed in an area and locations of the multiple passive beacons; an image sensor for capturing images and a processor. The processor is configured to identify patterns of at least one passive beacon of the multiple passive beacons from the captured images; select a specific passive beacon of the multiple passive beacons to estimate a location of the mobile robot; extract the mobile robot's location from the location of the specific passive beacon; compute the mobile robot's direction by a pattern of the specific passive beacon.

The processes described above are performed by a computerized system or device, for example a server, a laptop, a tablet computer, a personal computer. The computerized system or device comprises a processor that manages the processes. The processor may include one or more processors, microprocessors, and any other processing device. The processor is coupled to the memory of the computerized system or device for executing a set of instructions stored in the memory.

The computerized system or device comprises a memory for storing information. The memory may store a set of instructions for performing the methods disclosed herein. The memory may also store the candidates' data, the training set, the test set, rules for building the software model and the like. The memory may also store rules for moving the radar, for example moving along the rail or moving using an arm, based on an event, or based on data extracted from the radar's measurements. The memory may store data inputted by a user of the computerized system or device, such as commands, preferences, information to be sent to other devices, and the like. The computerized system or device may also comprise a communication unit for exchanging information with other systems/devices, such as servers from which the candidates' data is extracted.

While the disclosure has been described with reference to an exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for estimating a location of a mobile robot in an area, the area having multiple passive beacons, the method comprising:
capturing images by an image sensor of the mobile robot;
wherein the multiple passive beacons have substantially identical patterns;
identifying patterns of at least one passive beacon of the multiple passive beacons from the captured images;
selecting a specific passive beacon of the multiple passive beacons to estimate a location of the mobile robot;
extracting the mobile robot's location from the location of the specific passive beacon; and
computing the mobile robot's direction by a pattern of the specific passive beacon.

2. The method of claim 1, further comprising:
the mobile robot storing multiple different patterns of passive beacons located in the area;
extracting a specific pattern from the captured images; and
comparing the specific pattern with at least one of the multiple different patterns.

3. The method of claim 2, further comprising:
storing locations of the multiple passive beacons;
obtaining an estimated location of the mobile robot from sensors located in the robot; and
determining an order of comparing the specific pattern with the multiple different patterns according to the locations of the multiple passive beacons and the robot's estimated location.

4. The method of claim 1, further comprising maneuvering image sensors of the mobile robot relative to a body of the mobile robot, wherein the image sensor is maneuvered to point towards an estimated location of the multiple beacons.

5. The method of claim 1, further comprising:
estimating a distance between the mobile robot and candidate passive beacons from which reflections are captured by the image sensor; and
filtering the candidate passive beacons according to the estimated distance from the mobile robot.

6. The method of claim 1, further comprising:
the mobile robot storing geometric characteristics of the passive beacons; and
filtering reflections from multiple passive beacons that do not match the geometric characteristics of the passive beacons.

7. The method of claim 1, further comprising estimating that the reflection represents the specific passive beacon of multiple candidate beacons based on data from sensors of the mobile robot.

8. The method of claim 1, further comprising emitting light from the mobile robot when moving in the area and capturing an image in the direction of the emitted light to collect reflections to the light.

9. The method of claim 1, wherein the specific passive beacon is a passive beacon closest to the mobile robot at the time of capturing the images

10. The method of claim 1, further comprising extracting the robot's height from the image based on a size of the pattern in the captured images.

11. The method of claim 1, wherein a single passive beacon of the multiple passive beacons having a unique pattern; wherein other patterns are associated with at least two passive beacons of the multiple passive beacons.

12. A mobile robot, comprising:
a body;
an actuator for moving the body;
a memory for storing one or more patterns of multiple passive beacons placed in an area and locations of the multiple passive beacons;
image sensor for capturing images; and
a processor configured to
identify patterns of at least one passive beacon of the multiple passive beacons from the captured images,
select a specific passive beacon of the multiple passive beacons to estimate a location of the mobile robot,
extract the mobile robot's location from the location of the specific passive beacon, and
compute the mobile robot's direction by a pattern of the specific passive beacon.
